(19) United States
(12) Patent Application Publication
(10) Pub. No.: US 2005/0189180 A1
(43) Pub. Date: Sep. 1, 2005

(54) Method and apparatus for reducing the energy consumption of elevators equipped with SCR drives

(76) Inventors: Rory Smith, El Cajon, CA (US); Richard Peters, Great Kingshill (GB); Lutfi Al-Sharif, London (GB)

Correspondence Address: FROST BROWN TODD, LLC, 2200 PNC CENTER, 201 E. FIFTH STREET, CINCINNATI, OH, 45202, US

(21) Appl. No.: 10/788,854

(22) Filed: Feb. 27, 2004

(51) Int. Cl. H02P 1/26

(52) U.S. Cl. 187/296

(57) ABSTRACT

The invention is directed to an apparatus and methods for enhancing the energy efficiency of a variable speed drive (VSD) used to control an elevator by disconnecting the VSD from the AC power supply grid when the elevator is idle and reconnecting the VSD when the elevator becomes active. One embodiment of the invention comprises an alternating current power supply grid, one or more variable speed drives, contactors connected between the alternating current power supply grid and the variable speed drive(s) that are used to connect or disconnect the variable speed drive(s) from the alternating current power supply grid, and, a control system that controls the contactors. The contactors may comprise a coil which is powered by the control system to either connect or disconnect the VSDs and the AC power supply grid.

### BACKGROUND

Virtually all of the high speed elevators installed prior to 1975 used direct current (DC) motors. The source of the direct current was typically a motor-generator (MG) set. The alternating current (AC) motor of the MG set was connected to an AC supply grid powered by the three phase AC supply of the building.

Between 1975 and the early 1990's the majority of new high speed elevators were manufactured with DC motors supplied by a variable speed drive (VSD) that consisted of an isolation transformer, silicon controlled rectifiers, control electronics, and a ripple filter. This same VSD system was also used to modernize thousands of existing elevators. The existing DC motor was retained and the MG was replaced by the VSD.

The silicon controlled rectifier variable speed drive (SCR VSD) is considered to be much more energy efficient than the MG set because the MG set was turning even if the elevator was stopped. However, the SCR VSD wastes significant energy because the isolation transformer was always connected to the power supply grid. Additionally, the SCR VSD supplied standby power (approximately 50% of running current) to the motor field. This power was typically supplied 24 hours a day, 365 days a year. The only time the VSD was not connected and consuming power was during maintenance.

### SUMMARY OF THE INVENTION

The invention is directed to an apparatus and methods for enhancing the energy efficiency of a variable speed drive 15 (VSD) used to control an elevator by disconnecting the VSD from the AC power supply grid when the elevator is idle and reconnecting the VSD when the elevator becomes active. One embodiment of the invention comprises an alternating current power supply grid, one or more variable speed drives, contactors connected between the alternating current power supply grid and the variable speed drive(s) that are used to connect or disconnect the variable speed drive(s) from the alternating current power supply grid, and, a control system that controls the contactors. The invention may be powered by a three phase AC power source. The variable speed drives may comprise an isolation transformer having a line side, one or more silicon controlled rectifiers, a control circuit and a ripple filter and the contactor(s) could be connected to the line side of the isolation transformer of each variable speed drive. The contactors may comprise a coil which is powered by the control system to connect or disconnect the VSDs and the AC power supply grid. Solid-state devices may be used instead of contactors, and the control system may control the gates of the solid-state devices to connect or disconnect the VSDs and the AC power supply grid. In one embodiment, the control system disconnects VSDs that are idle for a fixed time period, such as 60 seconds.

### BRIEF DESCRIPTION OF THE DRAWINGS

FIG. 1 is a block diagram depicting an embodiment of the present invention.

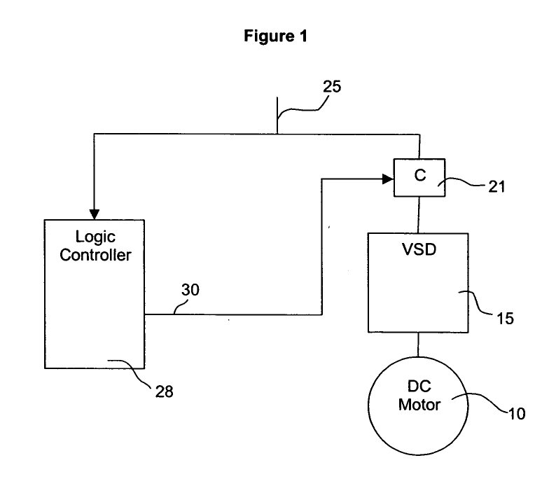

### DETAILED DESCRIPTION OF THE INVENTION

The invention enhances the energy efficiency of variable speed drives (VSD) used to control elevators by disconnecting the VSDs from the AC power supply grid when the elevators are idle and connecting the VSDs to the AC power supply grid when the elevators are or become active.

In preferred embodiment, an elevator is powered by a DC motor 10 controlled by a variable speed drive 15 (VSD) is having an isolation transformer, a plurality of silicon controlled rectifiers, control electronics, and a ripple filter. A three phase contactor 21 is connected to the line side of the isolation transformer of the VSD 15 and the AC supply grid 25. A control system, such as logic controller 28 is connected to AC supply grid 25 and has an output device 30 connected to the three phase contactor 21 that controls the three phase contactor to disconnect the VSD 15 from an AC supply grid 25 when elevator service is not required. When the control system 28 supplies power to the coil of the contactor 21, the contactor 21 connects the VSD 15 to the AC supply grid 25. When the control system 28 does not supply power to the coil of the contactor 21, the contactor 21 disconnects the VSD 15 from the AC supply grid 25. The control system 28 remains connected to and continues to be powered by the AC supply grid 25 even when the VSD 15 is disconnected from the AC supply grid.

In an alternate embodiment, the contactor is replaced with a solid state device, such as a switch. In this case, the control system has an output device that controls the gate of the solid state device.

The control system may include software, firmware or hardware to connect or disconnect the VSD from the AC supply grid based upon demand for an elevator. In one embodiment, the VSD is disabled if there is no demand for an elevator for a fixed period of time, such as 60 seconds. Since the VSD executes a startup sequence and self diagnostic routine that takes several seconds each time the VSD is connected or reconnected to the AC supply grid, the VSD should not be disabled each time the elevator stops at a floor.

It is envisioned that a typical elevator would have the VSD disabled over 12 hours a day during the work week and for a much longer time in periods of light use, such as weekends and holidays. A typical elevator consumes 1 to 2 kilowatts when on standby which can be saved with this invention.

1. An energy efficient elevator system comprising:
an alternating current power supply grid;
one or more variable speed drives for driving elevators motors;
one or more contactors connected between the alternating current power supply grid and the variable speed drive(s), and capable of connecting or disconnecting the variable speed drive(s) from the alternating current power supply grid; and
a control system connected to the alternating current power supply grid, the control system having an output device connected to the contactor(s) and controlling the contactors to connect or disconnect the variable speed drive(s) from the alternating current power supply grid.

2. The energy efficient elevator system of claim 1 comprising a three phase AC power source.

3. The energy efficient elevator system of claim 1 wherein:
the variable speed drive(s) comprise an isolation transformer having a line side, one or more silicon controlled rectifiers, a control circuit and a ripple filter; and,
the contactor(s) are connected to the line side of the isolation transformer of each variable speed drive.

4. The energy efficient elevator system of claim 1 or 3 wherein:
the contactors comprise a coil; and
the control system output device supplies power to the coil of the contactor to connect each variable speed drive to the alternating current power supply grid and cuts power to the coil of the contactor to disconnect each variable speed drive from the alternating current power supply grid.

5. An energy efficient elevator system comprising:
an alternating current power supply grid;
one or more variable speed drives for driving elevator motors;
one or more solid-state devices connected between the alternating current power supply grid and the variable speed drive(s), and capable of connecting or disconnecting the variable speed drive(s) from the alternating current power supply grid; and
a control system connected to the alternating current power supply grid, the control system having an output device connected to the solid-state device(s) and controlling the solid-state device(s) to connect or disconnect the variable speed drive(s) from the alternating current power supply grid.

6. The energy efficient elevator system of claim 5 wherein:
the solid-state device(s) comprise a gate; and
the control system output device closes the gate to connect each variable speed drive to the alternating current power supply grid and opens the gate to disconnect each variable speed drive from the alternating current power supply grid.

7. The energy efficient elevator system of claim 1 or 5 wherein the control system controls the contactor(s) to disconnect variable speed drive(s) that are idle for at least 60 seconds and connect variable speed drive(s) that are or become active.

8. A method of enhancing the energy efficiency of an elevator system by using the energy efficient elevator system of claim 1 or 5.
